(19) United States
(12) Patent Application Publication
(10) Pub. No.: US 2020/0250517 A1
(43) Pub. Date: Aug. 6, 2020

(54) SYSTEMS AND METHODS FOR CONTINUOUS & REAL-TIME AI ADAPTIVE SENSE LEARNING

(71) Applicant: Pathtronic Inc., San Francisco, CA (US)

(72) Inventors: Sateesh Kumar Addepalli, San Jose, CA (US); Vinayaka Jyothi, Sunnyvale, CA (US); Ashik Hoovayya Poojari, Sunnyvale, CA (US)

(21) Appl. No.: 16/528,549

(22) Filed: Jul. 31, 2019

Related U.S. Application Data
(60) Provisional application No. 62/801,049, filed on Feb. 4, 2019.

(51) Int. Cl. G06N 3/063; G06N 3/08; G06N 5/04

(52) U.S. Cl. CPC G06N 3/063; G06N 5/04; G06N 3/084

(57) ABSTRACT

Aspects of the present disclosure are presented for an autonomous adaptive AI self-learning, training and inferencing system and method that would provide extremely cost effective and energy efficient broad based AI solutions/applications that are personalized/customizable. In some embodiments, a proposed component is an intelligent sense neuro memory cell unit (ISN-MCU). The ISN-MCU acts as the basic building block for AI adaptive learning. Each ISN-MCU is capable of receiving input from the surrounding environment and then learning or making an inference about the received data. With enough time or many more ISN-MCUs in combination, the AI system may be capable of learning for what it was programmed for in real time and in a memory and time efficient manner.

### CROSS REFERENCE TO RELATED APPLICATION

This application claims priority to U.S. Provisional Application No. 62/801,049, filed Feb. 4, 2019, and titled “SYSTEMS AND METHODS FOR CONTINUOUS & REAL-TIME AI ADAPTIVE SENSE LEARNING,” the disclosure of which is hereby incorporated herein in its entirety and for all purposes.

### TECHNICAL FIELD

The subject matter disclosed herein generally relates to artificial intelligence. More specifically, the present disclosures relate to methods and systems for continuous and real time AI adaptive sense learning.

### BACKGROUND

Currently, the sensing world and the AI-learning, training & inferencing world have been largely separate and distinct. This has resulted in enormous data, network, storage processing, and energy load/need requirements that are bulky and expensive. Moreover, it is difficult to provide cost effective, personalized or customized continuous learning (training and real-time inferencing) to meet the requirements of a specific problem or group of problems that are distributed and widespread in nature. This requires miniaturized self-contained intelligent systems and methods that can self-sense, adapt, learn train and infer the environment/problem it is deployed for. Some examples include personalized continuous self-diagnostics, personalized adaptive comfort inside a vehicle/room, adaptive autonomous driving, and adaptive monitoring & detection.

When employing AI learning, detecting/discovering any activities, functions, behavior, events or phenomena hinges on the accurate learning of the sensor data associated with a given problem that is personalized/customized in nature. However, current mechanisms of sensing and sending all the data to be learned to the centralized unit increase the communication, storage, processing and energy needs as well as latency and cost. So continuous personalized/customized learning in a massively distributed fashion at the sense level is the key for the future for a cost effective, real-time and autonomous learning, training and inferencing. Employing a massively distributed process of ingesting sensing data, that may be referred to as intelligent sense learning, could detect/discover any personalized/customized activities, functions, behavior, events, or phenomena very quickly, or even immediately, at the sense level itself. This provides real-time and autonomous decision making capabilities without the need for constantly communicating with an uber unit.

### BRIEF DESCRIPTION OF THE DRAWINGS

Some embodiments are illustrated by way of example and not limitation in the figures of the accompanying drawings.

FIG. 1 shows a generic intelligent sense neuro memory cell unit (ISN-MCU) that serve as fundamental building blocks for generating larger adaptive self-learning AI structures, according to some embodiments.

FIG. 2 shows an example of the ISN-MCUs combined to form one adaptive intelligent processing logic unit (ADI-PLU).

FIGS. 3A and 3B show an example implementation of multiple ADI-PLUs that can be interconnected via a hierarchical non-blocking interconnect with a lookup and forwarding table for automatic forwarding of data between ADI-PLUs & their respective ISN MCUs, according to some embodiments.

FIG. 4 shows a functional block diagram of how an ADI-PLU may be used to create an AI model output using multiple sensors.

FIG. 5 shows an example of a combination audio visual ISN-MCU, according to some embodiments.

FIG. 6 shows a functional block diagram of how multiple sensors and associated sensor data may be converted into a read/write stream using the ISN-MCUs, according to some embodiments.

FIG. 7 shows an example of an ISN-MCU that utilizes lidar, according to some embodiments.

FIG. 8 shows an example of an ISN-MCU acting as a MEMS sensor, capable of detecting movement, according to some embodiments.

FIG. 9 shows an example of how an ISN-MCU may be configured to act as a chemical sensing unit, according to some embodiments.

FIG. 10 shows another example of an ISN-MCU, in the form of a biosensor, according to some embodiments.

FIG. 11 contains the details of a flowchart for how an ISN MCU processes sensing data, according to some embodiments.

FIG. 12 illustrates an example block diagram describing additional details of how input layers and hidden layers as described in FIG. 4 might be structured, according to some embodiments.

### DETAILED DESCRIPTION

Applicant of the present application owns the following U.S. Provisional Patent Applications, all filed on Feb. 4, 2019, the disclosure of each of which is herein incorporated by reference in its entirety:
U.S. Provisional Application No. 62/801,044, titled SYSTEMS AND METHODS OF SECURITY FOR TRUSTED AI HARDWARE PROCESSING;
U.S. Provisional Application No. 62/801,046, titled SYSTEMS AND METHODS FOR ARTIFICIAL INTELLIGENCE HARDWARE PROCESSING;
U.S. Provisional Application No. 62/801,048, titled SYSTEMS AND METHODS FOR ARTIFICIAL INTELLIGENCE WITH FLEXIBLE HARDWARE PROCESSING FRAMEWORK;
U.S. Provisional Application No. 62/801,050, titled LIGHTWEIGHT, HIGHSPEED AND ENERGY EFFICIENT ASYNCHRONOUS AND FILE SYSTEM-BASED AI PROCESSING INTERFACE FRAMEWORK;
U.S. Provisional Application No. 62/801,051, titled SYSTEMS AND METHODS FOR POWER MANAGEMENT OF HARDWARE UTILIZING VIRTUAL MULTILANE ARCHITECTURE.

Applicant of the present application also owns the following U.S. Non-Provisional Patent Applications, filed herewith, the disclosure of each of which is herein incorporated by reference in its entirety:
Attorney Docket No. 1403394.00003, titled SYSTEMS AND METHODS OF SECURITY FOR TRUSTED AI HARDWARE PROCESSING;
Attorney Docket No. 1403394.00006, titled SYSTEMS AND METHODS FOR ARTIFICIAL INTELLIGENCE HARDWARE PROCESSING;
Attorney Docket No. 1403394.00009, titled SYSTEMS AND METHODS FOR ARTIFICIAL INTELLIGENCE WITH A FLEXIBLE HARDWARE PROCESSING FRAMEWORK;
Attorney Docket No. 1403394.00015, titled LIGHTWEIGHT, HIGH SPEED AND ENERGY EFFICIENT ASYNCHRONOUS AND FILE SYSTEM-BASED AI PROCESSING INTERFACE FRAMEWORK; and
Attorney Docket No. 1403394.00018, titled SYSTEMS AND METHODS FOR POWER MANAGEMENT OF HARDWARE UTILIZING VIRTUAL MULTILANE ARCHITECTURE.

Aspects of the present disclosure are presented for an autonomous adaptive AI self-learning, training and inferencing system and method that would provide extremely cost effective and energy efficient broad based AI solutions/applications that are personalized/customizable.

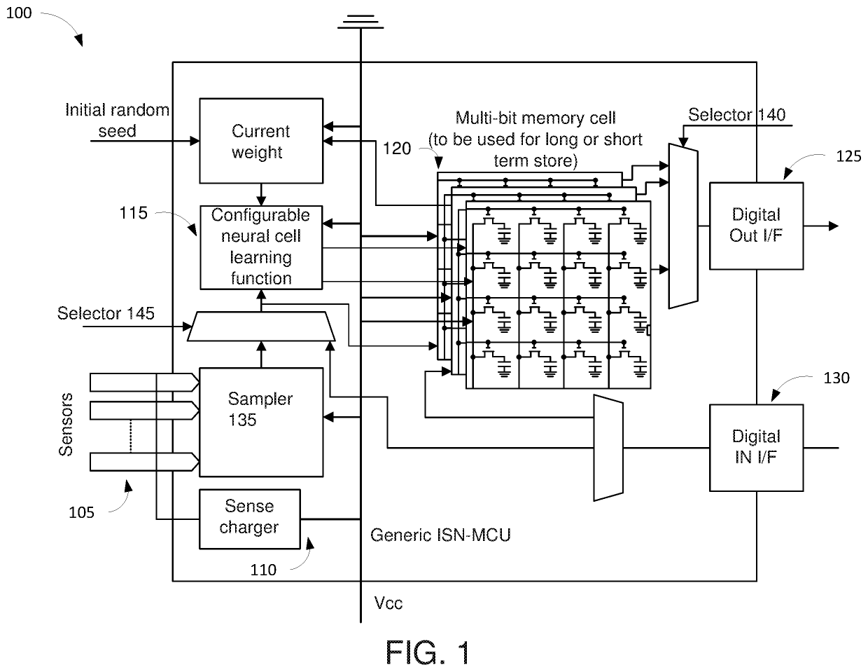

In some embodiments, a proposed component is an intelligent sense neuro memory cell unit (ISN-MCU). The ISN-MCU acts as the basic building block for AI adaptive learning. Each ISN-MCU is capable of receiving discrete/continuous sensed input from the external environment, which can include the surrounding environment, elements, materials, entities, and/or activities in contact or from another ISN-MCU and then adaptively learning and/or making an inference/decision about the received data. With enough time or many more ISN-MCUs in combination, the AI system may be capable of adaptively learning for what it was programmed, configured, and/or trained for in real time and in an efficient manner into a memory. Referring to FIG. 1, a generic ISN-MCU is shown. In this example, the ISN-MCU has the following components:

1. One or more sense elements or sensors 105 (chemical, photonic, electrical, biological, MEMs) with a sampler 135 with continuous sensing;

2. Optional sense charger 110. Sensing can charge an appropriate capacitor to store enough charge to be used by the components within the ISN-MCU;

3. A neural cell 115. This includes various tunable/configurable/programmable adaptive learning & decision functions and associated parameters for training and inference;

4. At least one memory cell 120 (short term, long term store e.g., volatile memory cell such as RAM/SRAM/BRAM/Cell and/or non-volatile memory cell such as, NAND Cell/TLC/SLC/MLC etc.), which shown in FIG. 1 includes a multi-bit memory cell configured for multiple types of memory storage;

There several types of multi-bit memory cells: an input cell; a weight or adaptivity quotient cell; and an output cell; and

5. A digital input/output interface 130, 125, respectively, to a digital interconnect.

The ISN-MCU is exposed via a digital input/output interface 130, 125, to the digital domain.

Depending on the request, the output going via the digital OUT interface (I/F) 125 is read from either the input cell, weight/adaptivity quotient cell, or output cell using an output mux selector logic 140.

Similarly, depending on the request, data coming via the Digital IN interface is sent to the weight cell, input cell, or the neural cell input selector using appropriate digital interface (I/F) input demux selector logic 145.

Depending on the neural cell input mux selector logic, input to the neural cell can come from the sense sampler 135 or from the digital input demux.

The sampler 135 sends input sample data to the input memory cell 120. The neural cell sends updated weight/adaptivity quotient values to the weight/adaptivity quotient memory cell, and the output to the output memory cell. The weight/adaptivity/quotient values are used to adjust the AI solution model, that are based on the conclusions, decisions or inferences developed by the ISN-MCU. The output may be a definitive conclusion, such as an AI solution model with a complete iteration of decisions/inferences made by the ISN-MCUs.

Based on the type of sensing, there can be several types of ISN-MCUs, such as:

Photo ISN-MCU;

MEMS ISN-MCU;

Radar ISN-MCU;

Lidar ISN-MCU;

Chemical ISN-MCU; and

Bio Component ISN-MCU.

Other sensor types are possible. There may also be a combination thereof, such as:

Bio Chemical ISN-MCU; and

Audio Visual ISN-MCU.

Example implementations of some of these cells will be described more below.

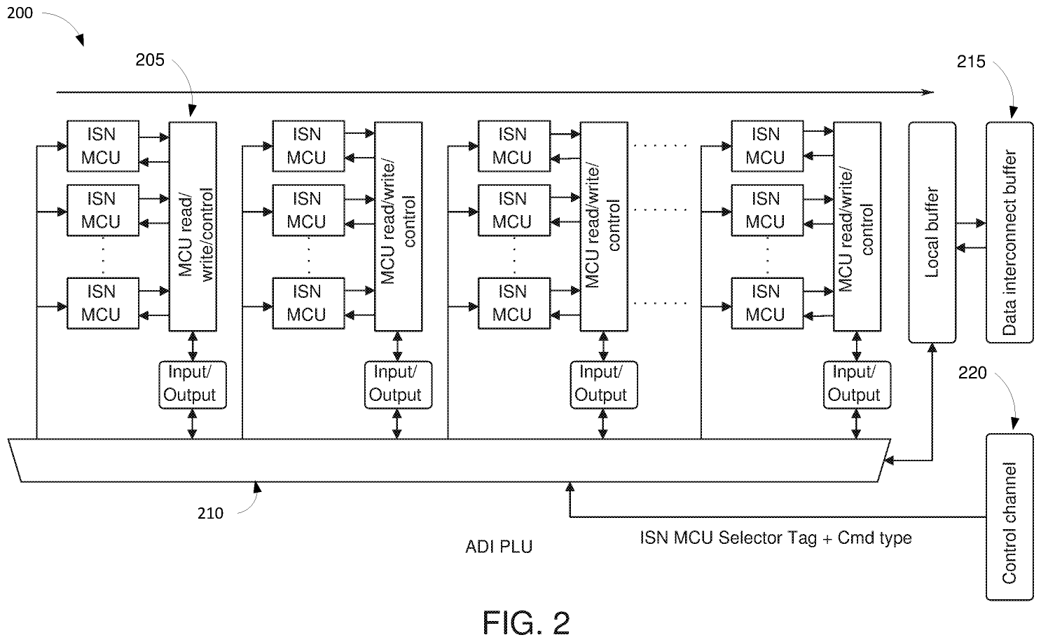

The ISN-MCUs serve as the basic building blocks of a larger AI system. A collection of ISN- MCUs can be combined in a particular structure to form an adaptive intelligent processing logic unit (ADI-PLU). Illustration 200 of FIG. 2 shows an example of the ISN-MCUs combined to form one ADI-PLU.

An ADI-PLU may contain a homogeneous or heterogeneous collection of ISN-MCUs and acts like a memory block that is connected to a data and control interconnect as described later in this section. In some embodiments, the collection of ISN-MCUs are addressable like memory cells. Each of the ISN-MCUs within an ADI-PLU can be accessed (read/write) just like one or more memory cell(s) using appropriate selector tags and command types. For example, as shown in illustration 200, multiple ISN-MCUs are coupled to an MCU read/write/control circuit, e.g., block 205, communication of which is ultimately facilitated through a bus 210. The connections to a single ADI-PLU may be made through the data interconnect buffer 215 and the control channel 220.

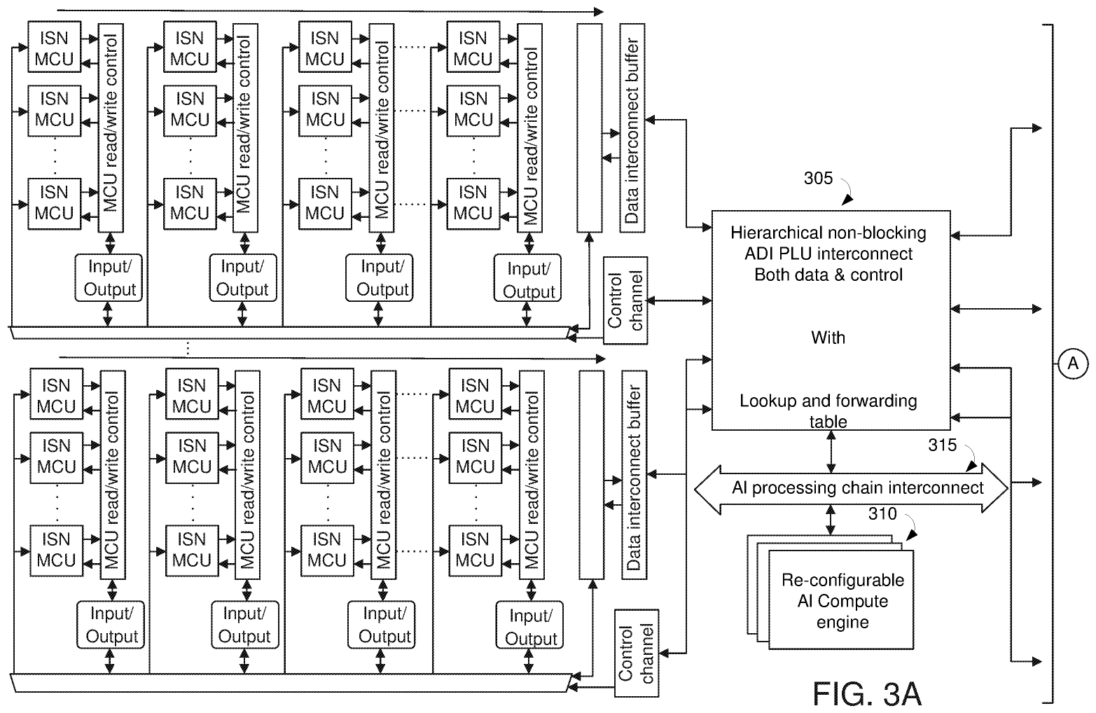

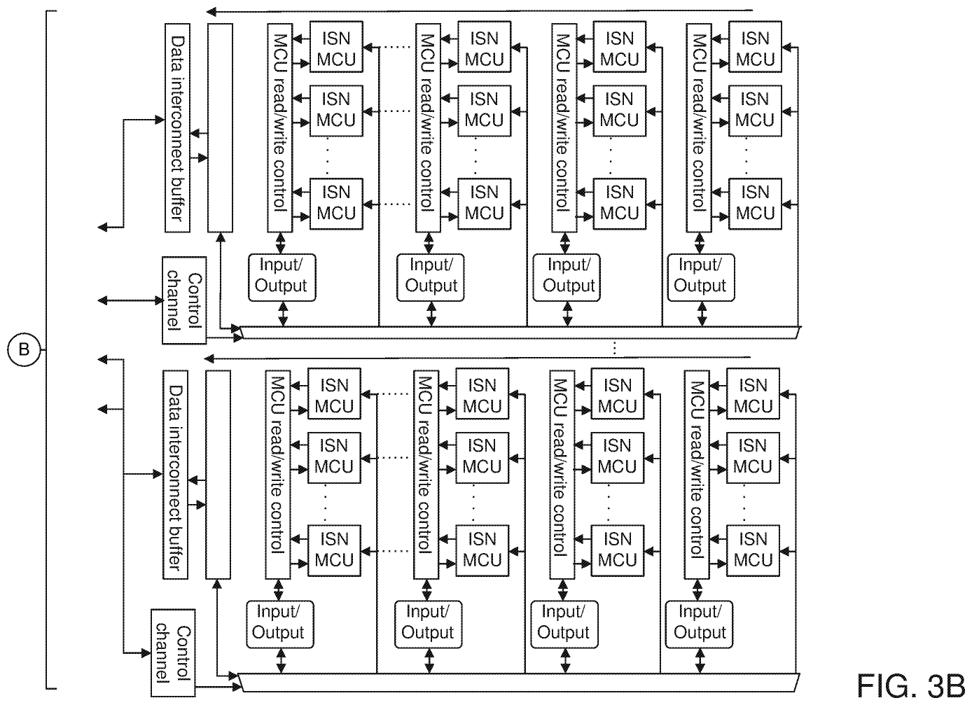

There can be one or more ADI-PLUs that can be interconnected via a hierarchical non-blocking interconnect with a lookup and forwarding table for automatic forwarding of data between ADI-PLUs & their respective ISN MCUs. An example of this interconnecting is shown in FIGS. 3A and 3B, with the hierarchical non-block ADI PLU interconnect block 305 as shown. These connections are made to the control channel 220 (see e.g., FIG. 2) and the data interconnect buffer 215. The data may be supplied through the data interconnect buffer 215 while the control channel provides the instructions to the various ISN-MCUs within a single ADI-PLU. Types of forwarding from/to an ADI-PLU and their respective ISN MCUs include one-to-one forwarding, one-to-many forwarding, many-to-one forwarding & many-to-many forwarding, respectively.

Moreover, ADI-PLUs can be accessed from re-configurable AI compute engines 310 as a typical memory block. The engines 310 may drive instructions to the ADI-PLUs via the non-blocking ADI-PLU interconnect 305. It can be defined, organized, and tied to the overall AI processing chain via the AI processing chain interconnect bus 315.

Multiple sets of ADI-PLUs can be accessible from a re-configurable AI compute engine 310. Attorney Docket No. 1403394.00005, U.S. Provisional Application No. 62/801,046, titled “SYSTEMS AND METHODS FOR ARTIFICIAL INTELLIGENCE HARDWARE PROCESSING,” describes in more detail how the AI compute engine and AI processing chain may operate.

ADI-PLUs can be organized, for instance, to represent a set of inputs, weights/adaptivity quotients and outputs that can represent a user specified AI learning/solution model.

Instead of training in the traditional processing domain, they learn by sensing and adjusting data which is stored in multi-bit memory cells to represent values that may correspond to AI learning model input, weight/adaptivity quotient and output.

Creating the model and associating the sense input, weight/adaptivity quotient and output to the AI learning/solution model can be done by domain specific scientists based on a given problem and its expected outcome or can be done automatically through re-enforced feedback learning, according to some embodiments. The users may set up which ISN-MCUs to use to acquire the desired data, then the configured hardware structure may ingest the sensed data to adaptively learn from what they pick up.

A user specified AI model layer node can be mapped to one or more ISN-MCUs of one or more ADI-PLUs. If there is a connection between nodes, and moreover if the nodes happen to be ISN MCUs of another ADI-PLU, then a forwarding look-up entry may be created in the ADI-PLU interconnect 305. An appropriate forwarding to the next ISN-MCU or to the appropriate AI-PLUs for next layer processing, depending on the AI model node mapping, will be created for the corresponding neural connection.

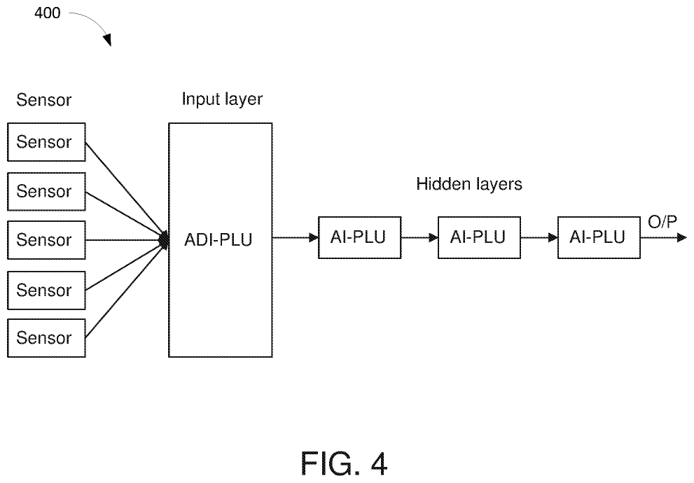

Referring to FIG. 4, illustration 400 shows a functional block diagram of how an ADI-PLU may be used to create an AI model output using multiple sensors. The AI model, which also may be referred to herein as an AI solution model, may be an output that solves a problem or a request made by a user. For example, an AI solution model may be the output by the AI system based on the user having requested of the AI system to generate a model that, when performed by the AI system, organizes images into various categories after being trained on a set of training data. These may be generated using the sensed data obtained by the multiple sensors. The sensor data from the multiple sensors may be used as input to an ADI-PLU, which acts as an input layer. There may be multiple hidden layers that process that data through other multiple AI-PLUs. The output may flow out of that.

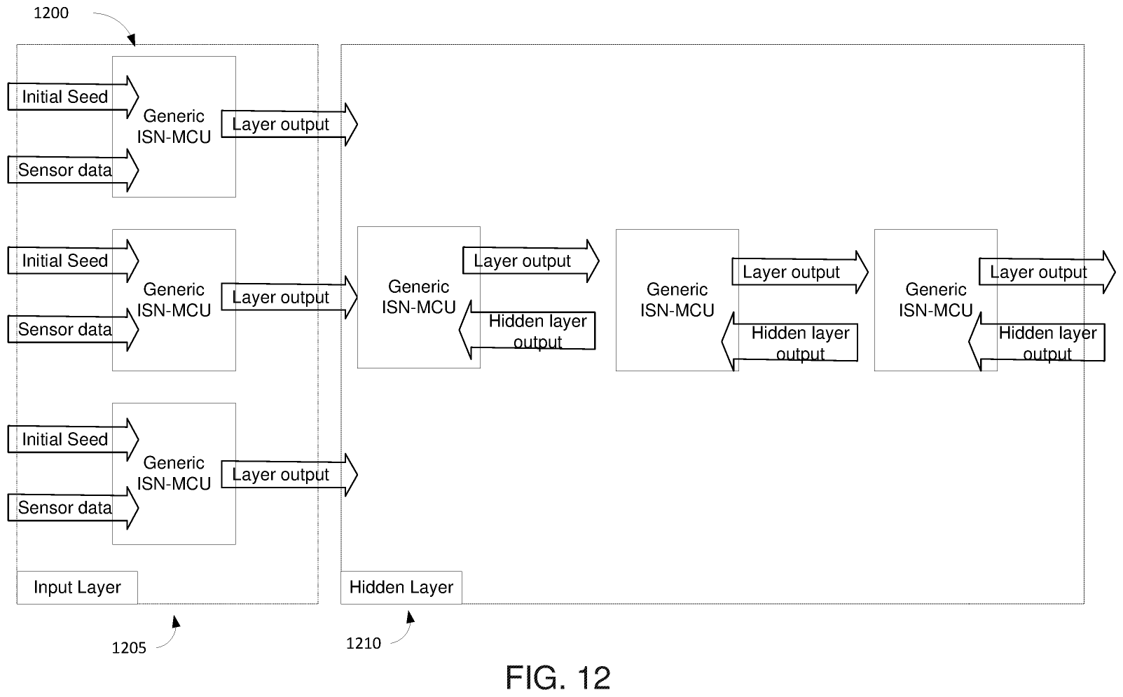

Still referring to FIG. 4, ADI-PLUs can participate in various configurations depending on the AI models of the future. There can be two types. One is a single, self-contained layer AI processing, and another may be a multi-layer (two or more layers) AI processing. An example of a single layered version would be a light neural net where the computation could be completed in one layer. An example of a multi-layered version are the ones where larger network should be fit in. FIG. 12 illustrates an example block diagram describing additional details of how these layers might be structured.

In the single layer self-contained AI Processing case, one or more ADI-PLUs can represent an AI model to continuously sense, neural process, and output the results to corresponding output cells.

In the multi-layer AI processing case, one or more ADI-PLUs can represent a first layer, one or more ADI-PLUs can represent an intermediate layer (e.g., hidden layer), there can be one or intermediate layers, and finally one or more ADI-PLUs can represent an output layer.

All the mapped ISN MCUs of an ADI-PLU will continuously sense, collect the sensing data, neural process and write results to the corresponding memory cell within.

Since an ADI-PLU acts as a typical memory block, its ISN-MCU elements are addressable through the interconnect. So if there are 100 ISN-MCUs, the model could be loaded to the ADI-PLU memory block, which will run on its own, depending on the senor data. Once the output is generated, the output can be sent to the appropriate next set of ISN MCUs of one or more ADI-PLUs or to an AI-PLU of the re-configurable AI compute engine, depending on how the hidden layer nodes are mapped.

Each ISN-MCU within an ADI-PLU contains a current weight/adaptivity quotient cell, a configurable neural learning cell, and a selector to select input cells, weight/adaptivity quotient cells and output cells. Also, many ADI-PLUs can be interconnected via an ADI interconnect forwarding table to send one output from one to another. These input cells may be 2 d arrays of location, but to the outside interface it will look like a memory cell with address and memory. So the current sensor could run its layers or adjacent sensors could use it for its hidden layer computation.

Audio Visual ISN-MCU

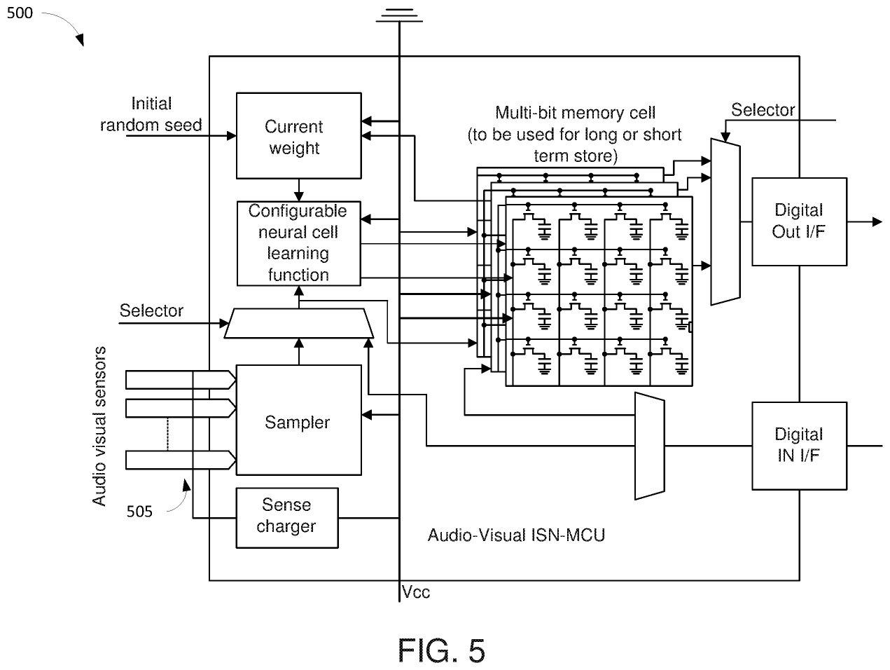

Referring to FIG. 5, illustration 500 shows an example of a combination audio-visual ISN-MCU. The components of the ISN-MCU are generally the same as shown in the example generic ISN-MCU of FIG. 2, but the type of sensors here differ. For example, audio-visual sensors 505 are included, which may include types of microphones or cameras. The input pixel data is read through one of the sensors 505. As an example, the sensor 505 may be an image sensor. So image data will be coming from the sensor 505, which may be sampled by the sampler. The output is fed to the configurable ISN-MCU learning function which will support functions such as the initial layer in the models. The configurable ISN-MCU cell will read the current weight/adaptivity quotient, input data and update the multi-bit memory cell, which will store the weights/adaptivity quotients for long term and for short term purposes. Again, the weights/adaptivity quotients may be used by the learning algorithm to adjust the AI solution model. Based on what the ISN-MCU(s) observe through their sensed learning, the AI solution model may be adjusted using the resulting weights/adaptivity quotients.

Here, the learning happens instantaneously by the configurable ISN-MCU cells. The configurable ISN-MCU can be configured to be an RNN, LSTM, GRU, CNN etc., or some combination of these. The weights/adaptivity quotients are preconfigured in the cell using the previously stored values.

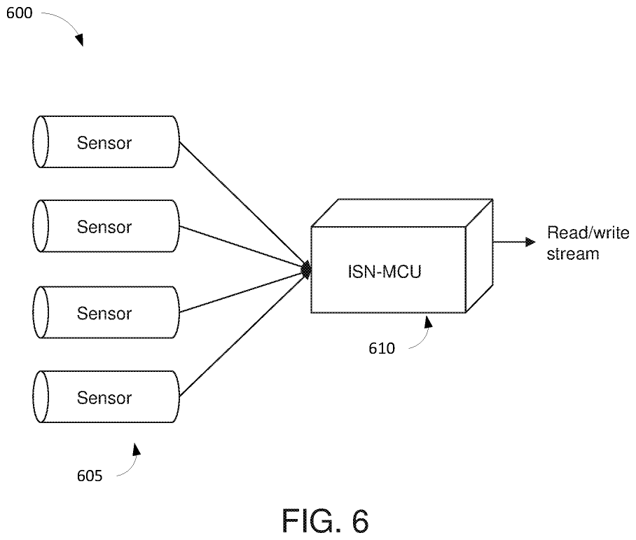

Illustration 600 of FIG. 6 shows a functional block diagram of how multiple sensors and associated sensor data may be converted into a read/write stream. The sensor output values from multiples sensors 605 are sampled and interfaced to configurable ISN-MCU cells in 2D. So a group of pixels are connected to a single configurable ISN-MCU cell. The sensors are grouped and given as an input ISN-MCU cell that, with the preconfigured weights/adaptivity quotients, will give the output to the model present in the ISN-MCU cell. For example, in FIG. 6, four sensor pixels 605 are connected to an ISN-MCU cell 610. The ISN-MCU cell will calculate the output and update the weight/adaptivity quotients if required. All the weights are present in the multi-bit 2D RAM cell. Once the weight/adaptivity quotient is updated, according to the learning algorithm, the weight/adaptivity quotient is updated in the corresponding 2D RAM cell. This configuration gives real time sensing and learning of image data is given to the memory. Weights/adaptivity quotient are read by the neurons and updated by the neurons. Once this layer is computed, the output could be streamed to other ADI-PLUs or AI-PLUs.

In some cases, there may be multiple types of sensors 605 that provide different types of information. Thus, before the output is provided to other ADI-PLUs or AI-PLUs, the ISN-MCU that receives these sensor information may include multiple types of information. This may create a more robust neural network.

Lidar ISN-MCU

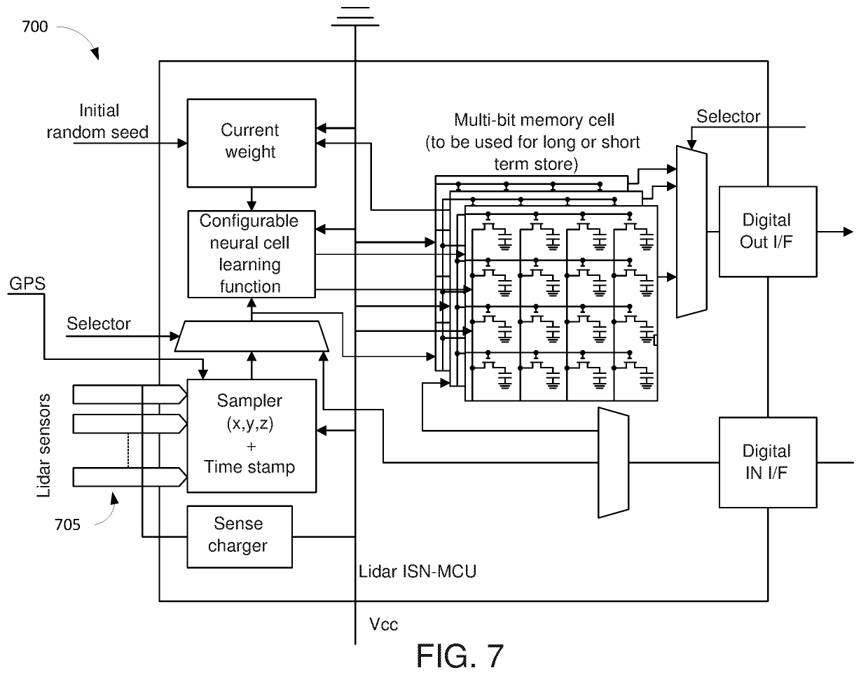

FIG. 7 shows an example of an ISN-MCU that utilizes lidar. The one or more lidar sensors is a sensor that senses both distance and imagery data. It contains the time stamp from the time of the snap shot. It also contains the geo location of the data in some embodiments. Here, the data contains RGB information, the depth, and the time stamp of the information. So this information is fed into the set of the ISN-MCU that will process the initial layer output of a model. So depending on the model, the weight/adaptivity quotient of the ISN-MCU neural cell learning function adapts to the model set by the user. The ISN-MCU neural cell learning function will conduct continuous learning according to the input data and the set parameters. Hence, these modules will adapt to the environment depending on the input.

In this way, the sensor in combination with the ISN-MCU will not need any software modification in the future because the model will be updated according to the input.

MEMS ISN-MCU

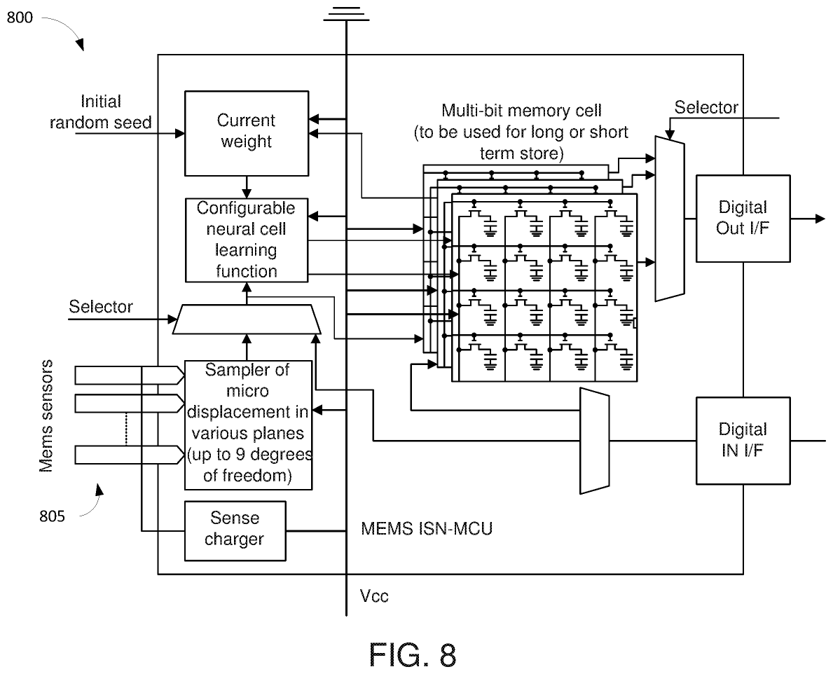

Illustration 800 of FIG. 8 shows an example of an ISN-MCU acting as a microelectromechanical (MEMS) sensor, such as accelerometer, gyroscopes, and the like. If the MEMS sensor 805 is fused with AI, then it will lead to accurate detection and analysis of movements. The sensor data from the one or more sensors 805 may be a combination of acceleration data in 3-dimensions, momentum values in 3-dimensions, and direction values in 3-dimensions. All the data can be sent to different sets of an ISN-MCU network that will track momentum, distance and direction. All the three ISN-MCU network output could be combined to form a 9 degree intelligent sensing ability. The hidden layers in the ISN-MCU network will run the data and give final interpretation of the data. For example, all the data could be used in the ISN-MCU network to fuse it and give a final output to the computer. This could help improve the edge computing. For example, the vibrations in an engine could be used to detect the faulty part in the engine, etc.

Recognizing the user activity hinges on the accurate classification of the MEMS sensor data. Sending all this data to a cloud server to process increases the data bill, data transmission bill and computation delay for the user. So continuous learning in the edge computing is the key for the future. This way, an intelligent sensor could detect the user activity or functions in real time and with close proximity to the actual user activity. It helps reduce the communication lag between the central unit and another sensor, the storage between them, and latency between them. It is desirable to advance towards a lower AI inference and learning at the sensor stage itself

Pushing all the AI processing to the MAIN engine reduces the AI processing power. Also, storing all the AI data would be increase storage dramatically. Therefore, it is better to process the sensor data in real time and in the immediate proximity of the actual user activity.

Chemical ISN-MCU

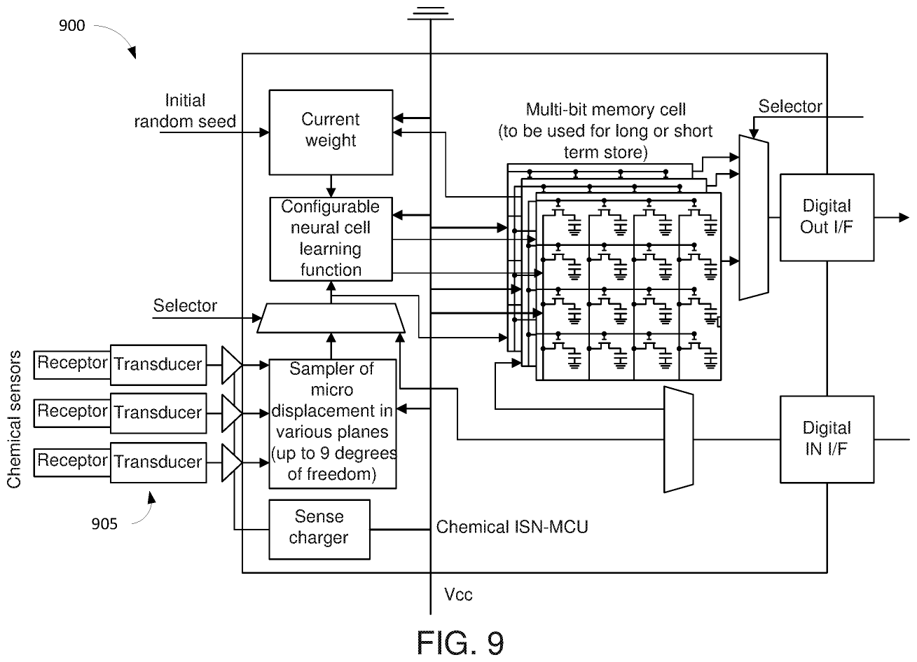

Referring to FIG. 9, illustration 900 shows an example of how an ISN-MCU may be configured to act as a chemical sensing unit. Chemical sensors 905 are sensors that convert chemical signatures into analytical useful digital signals. This signal could be used by the electronics to make classifications. This ISN-MCU has three parts: a receptor, a transducer and an amplifier, which is exemplified by the amplifier logic gate symbol. The receptors will have membranes that will react with an analyte medium. The receptor will respond to a substance or a group of substance. It performs molecular recognition and forwards the response to the transducer. The transducer will contain the transducing function. It will convert the non-electrical quantity into an electrical quantity.

Smell Based ISN-MCU Sensor

The chemical ISN-MCU may include a few subsets of specialized types of ISN-MCU. For example, the ISN-MCU network that is fused with sensors could learn to smell different smells and categories that it is also equipped with self-learning architecture to be fused with. This novel technology could be used in airports to detect different materials entering the airports. It could detect bombs and other contraband materials entering the airport. It could also do quality control, etc.

Taste Based ISN-MCU Sensor

As another example, a taste based ISN-MCU sensor may also be conceivable. It will be a combination of chemical, microbial, and PH sensors. It could detect whether you have adequate glucose level, poison, etc.

Bio ISN MCU

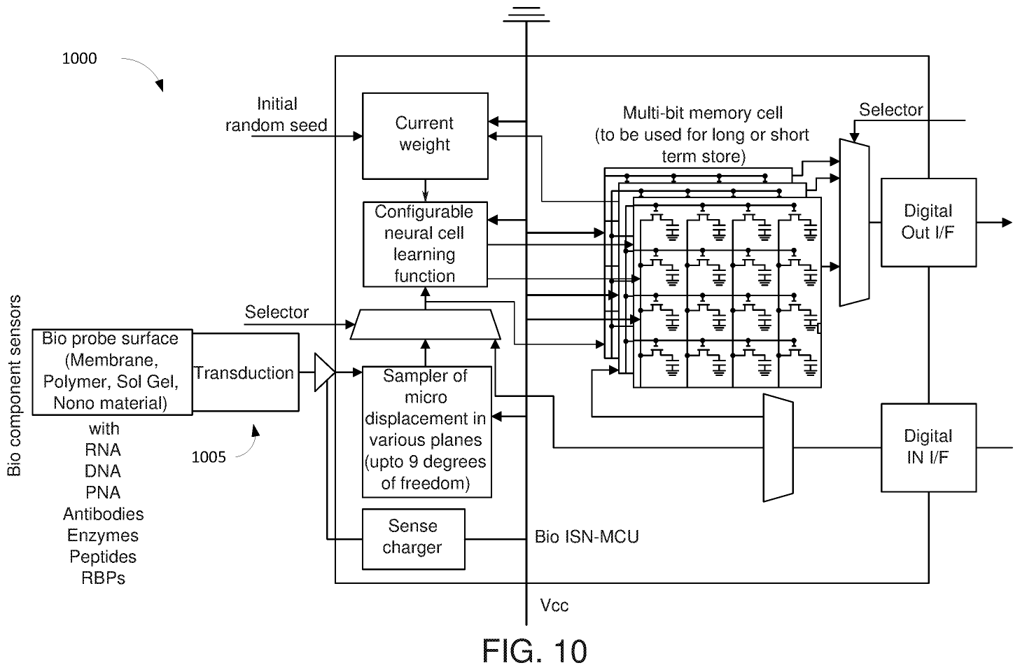

Illustration 1000 of FIG. 10 shows another example of an ISN-MCU, in the form of a biosensor. The biosensor 1005 includes a bio probe surface and a transduction element, coupled to an amplifier. The biosensor is a sensing device that is comprised of a biological entity as an important part of assembly during the analyte detection. The biosensor could be for example, used for sensing the lactate level in blood. Assessing a patient's health condition in continuous surveillance during a surgery, for example, can be done by biosensors which can detect the lactate in blood. If this ISN-MCU based lactate sensor is used for hundreds of patients, then it can learn the behavior of the effect of lactate on each patient and predict different health conditions depending on the concentration in blood.

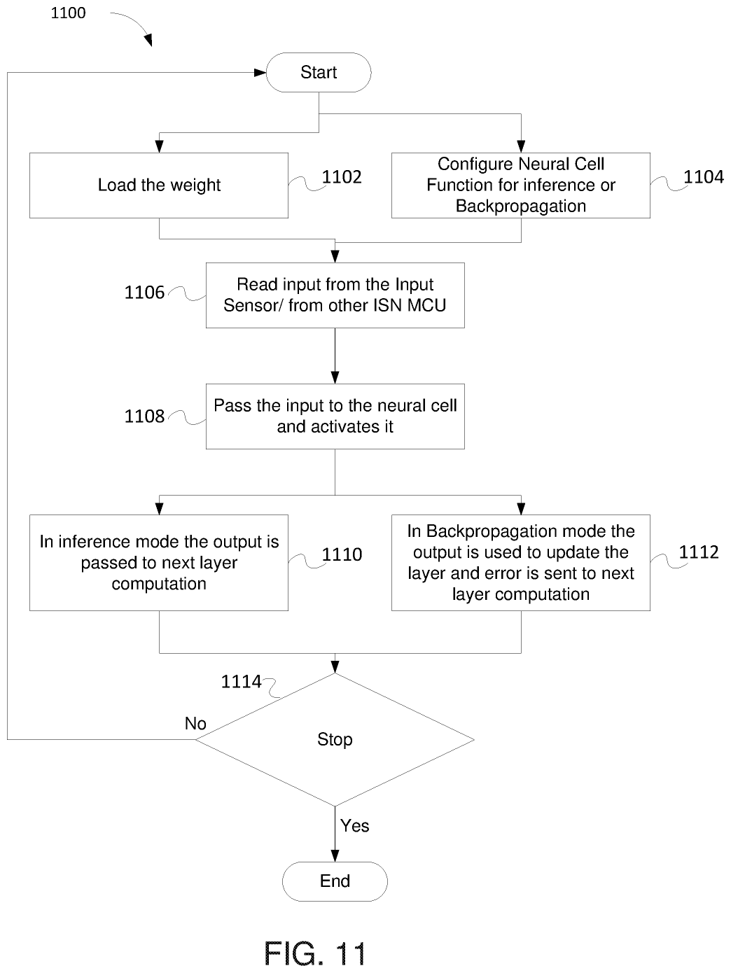

FIG. 11 contains the details of a flowchart 1100 for how an ISN MCU processes sensing data, according to some embodiments. The ISN MCU is capable of performing both learning and inference at the same time, due to the unique architecture involving the neural cell present in every ISN MCU. The neural cell is the place where the inference function runs or the learning function will run on the input sensing data, weight and previous layer output, depending. Thus, it will calculate the error, and this error is added to the weights in the multi-bit neural cell. Hence, learning and inference functionality is available side by side, which imitates the intelligence learning present in the living organism. This infrastructure unique on silicon substrates.

The flowchart 1100 in FIG. 11 provides two different paths with certain steps being the same, where the leftmost path indicates how an ISN MCU may operate when performing inference operations, while the rightmost path indicates what may occur during backpropagation.

Starting at block 1102, during inference, the ISN MCU may load appropriate weights from the weight table stored in the ISN MCU (see e.g., FIG. 1). At block 1106, the ISN MCU may then read inputs from the sensors and/or received from other ISN MCUs. At block 1108, these inputs are then passed to the neural cell of the ISN MCU and the neural cell is then activated. The neural cell performs processing to interpret the input data, whether from the sensors locally or from other ISN MCUs, through the context of the weights obtained in its weight table. The output is then passed to the next layer of computation, whether it be an additional ISN MCU or may move on to a larger level with another ADI PLU, at block 1110. This process may be repeated if commands are given to do so, such as by an orchestrator associated with the larger ADI PLU structure.

During backpropagation, starting at block 1104, the ISN MCU may configure the neural cell function for backpropagation rather than inference functionality. The same steps at blocks 1106 and 1108 are conducted, but this time the input values are simply received without incorporating weights. At block 1112, the output generated by the neural cell using the input data is used to update the layer and error instead of simply being passed along to draw conclusions during inference. That is, the backpropagation mode is used to adaptively learn from the sensed data and update the ISN MCUs. This process may continue until instructions are given externally for this mode to stop.

Each neural cell may be configured differently to handle the different types of sensing data obtained for the specific type of ISN MCU, however. In addition, different weights may be applied for each type of ISN MCU, which may also vary between the same type of ISN MCU, depending on the type of data each has received.

For example, in an autonomous driving case, two sensors may be used, such as lidar and image sensors, and so the lidar and image ISN MCUs would be used in the sensor side. Then in the hidden layer, the AI PLU or some more layers of ISN MCUs would be used.

Referring to FIG. 12, diagram 1200 shows an example architecture for how the input layer and hidden layers of a string of ADI-PLUs and AI-PLUs may be arranged using ISN-MCUs as building blocks, according to some embodiments. FIG. 12 provides a more detailed example of the structure discussed in FIG. 4. Here, the input layer 1205 includes multiple ISN-MCUs, shown here as generic ISN-MCUs, though any specific ones may be used that are configured for providing inference and learning of specific types of sensor data. For each ISN-MCU in the input layer, it receives an initial seed of weights as well as the appropriate sensor data from the appropriate types of sensors. These ISN-MCUs produce an output for that initial input layer, using for example the process described in FIG. 11 according to the structures described in FIG. 1, for example (or other ISN-MCUs described herein). This output serves as the input to the hidden layer 1210, which may actually be a series of ISN-MCUs that operate serially or sequentially. The layer output provided by the input layer may be a first input to a first ISN MCU in the hidden layer 1210, which then gets passed to a second ISN-MCU and then again to a third ISN-MCU in the hidden layer 1210. Using the output data from the input layer, each ISN-MCU in the hidden layer may produce an advanced data output that is referred to herein as a hidden layer output. This may get backpropagated to previous ISN-MCUs in the hidden layer that may be used for learning for later inference iterations.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms and that an illustrative form of the subject matter described herein applies regardless of the particular type of signal-bearing medium used to actually carry out the distribution.

Instructions used to program logic to perform various disclosed aspects can be stored within a memory in the system, such as DRAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, CD-ROMs, magneto-optical disks, ROM, RAM, EPROM, EEPROM, magnetic or optical cards, flash memory, or tangible, machine-readable storage used in the transmission of information over the Internet via electrical, optical, acoustical, or other forms of propagated signals (e.g., carrier waves, infrared signals, digital signals). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, DSP, PLD, programmable logic array (PLA), or FPGA), state machine circuitry, firmware that stores instructions executed by programmable circuitry, and any combination thereof. The control circuit may, collectively or individually, be embodied as circuitry that forms part of a larger system, for example, an integrated circuit, an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application-specific integrated circuit, electrical circuitry forming a general-purpose computing device configured by a computer program (e.g., a general-purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol which may be capable permitting communication using a Transmission Control Protocol/IP. The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum, titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims), are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general, such a construction is intended in the sense that one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense that one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those within the art that typically a disjunctive word and/or phrase presenting two or more alternative terms, whether in the description, claims, or drawings, should be understood to contemplate the possibilities of including one of the terms, either of the terms, or both terms, unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

### EXAMPLES

Various aspects of the subject matter described herein are set out in the following numbered examples:

Example 1. An intelligent sense neuro memory cell unit (ISN-MCU) apparatus, comprising: one or more sense elements configured to receive sensory data from an external environment; at least one sampler module configured to continuously sample the one or more sense elements to ingest the sensory data; a neural cell communicatively coupled to the at least one sampler and configured to adaptively learn using the received sensory data; a memory cell communicatively coupled to the neural cell and configured to store learned inferences from the neural cell based on what the neural cell learns from the received sensory data; and a digital input/output interface communicatively coupled to the memory cell and configured to interface the ISN-MCU to a digital domain.

Example 2. The ISN-MCU apparatus of Example 1, wherein the memory cell is a multi-bit memory cell comprising: an input memory cell configured to store input sampler data received from the at least one sampler module; a weight/adaptivity quotient memory cell configured to store weight/adaptivity quotient data; and an output memory cell configured to store an inference.

3. The ISN-MCU apparatus of Example 1 or 2, configured to provide visual and auditory inferences; wherein the one or more sense elements comprise audio and visual sensors.

4. The ISN-MCU apparatus of any of Examples 1 to 3, configured to sense distance and imagery data, wherein the one or more sense elements comprise lidar sensors.

5. The ISN-MCU apparatus of any of Examples 1 to 4, configured to identify chemicals, wherein the one or more sense elements comprise chemical sensors configured to convert chemical signatures into analyzable data.

6. The ISN-MCU apparatus of Example 5, wherein the chemical sensors comprise smell-based sensors.

7. The ISN-MCU apparatus of Example 5 or 6, wherein the chemical sensors comprise taste-based sensors.

8. The ISN-MCU apparatus of any of Examples 1 to 7, configured to sense biological data, wherein the one or more sense elements comprise a biosensor.

9. An adaptive intelligent processing logic unit (ADI-PLU) apparatus, comprising: a control channel configured to receive a command and transmit said command to multiple entities in parallel; a plurality of ISN-MCUs communicatively coupled in parallel to the control bus, each of the plurality of ISN-MCUs comprising: one or more sense elements configured to receive sensory data from an external environment; at least one sampler module configured to continuously sample the one or more sense elements to ingest the sensory data; a neural cell communicatively coupled to the at least one sampler and configured to adaptively learn using the received sensory data; a memory cell communicatively coupled to the neural cell and configured to store learned inferences from the neural cell based on what the neural cell learns from the received sensory data; and a digital input/output interface communicatively coupled to the memory cell and configured to interface the ISN-MCU to a digital domain; wherein each of the ISN-MCUs are configured to perform a learning operation in parallel with the other ISN-MCUs to learn from sensory data in an external environment based on receiving the command from the control channel.

Example 10. An apparatus comprising: a plurality of ADI-PLUs of Example 9, arranged in a hierarchical manner; and a hierarchical non-blocking interconnect module configured to interconnect the plurality of ADI-PLUs.

Example 11. The apparatus of Example 10, further comprising a lookup and forwarding table configured to provide automatic forwarding of data between the plurality of ADI-PLUs and their respective ISN-MCUs.

What is claimed is:

1. An intelligent sense neuro memory cell unit (ISN-MCU) apparatus, comprising:
one or more sense elements configured to receive sensory data from an external environment;
at least one sampler module configured to continuously sample the one or more sense elements to ingest the sensory data;
a neural cell communicatively coupled to the at least one sampler and configured to adaptively learn using the received sensory data;
a memory cell communicatively coupled to the neural cell and configured to store learned inferences from the neural cell based on what the neural cell learns from the received sensory data; and
a digital input/output interface communicatively coupled to the memory cell and configured to interface the ISN-MCU to a digital domain.

2. The ISN-MCU apparatus of claim 1, wherein the memory cell is a multi-bit memory cell comprising:
an input memory cell configured to store input sampler data received from the at least one sampler module;
a weight/adaptivity quotient memory cell configured to store weight/adaptivity quotient data; and
an output memory cell configured to store an inference.

3. The ISN-MCU apparatus of claim 1, configured to provide visual and auditory inferences;
wherein the one or more sense elements comprise audio and visual sensors.

4. The ISN-MCU apparatus of claim 1, configured to sense distance and imagery data, wherein the one or more sense elements comprise lidar sensors.

5. The ISN-MCU apparatus of claim 1, configured to identify chemicals, wherein the one or more sense elements comprise chemical sensors configured to convert chemical signatures into analyzable data.

6. The ISN-MCU apparatus of claim 5, wherein the chemical sensors comprise smell-based sensors.

7. The ISN-MCU apparatus of claim 5, wherein the chemical sensors comprise taste-based sensors.

8. The ISN-MCU apparatus of claim 1, configured to sense biological data, wherein the one or more sense elements comprise a biosensor.

9. The ISN-MCU apparatus of claim 1, configured to perform artificial intelligence (AI) model inference operations while simultaneously performing self-learning operations using backpropagation techniques.

10. An adaptive intelligent processing logic unit (ADI-PLU) apparatus, comprising:
a control channel configured to receive a command and transmit said command to multiple entities in parallel;
a plurality of ISN-MCUs communicatively coupled in parallel to the control bus, each of the plurality of ISN-MCUs comprising:
one or more sense elements configured to receive sensory data from an external environment;
at least one sampler module configured to continuously sample the one or more sense elements to ingest the sensory data;
a neural cell communicatively coupled to the at least one sampler and configured to adaptively learn using the received sensory data;
a memory cell communicatively coupled to the neural cell and configured to store learned inferences from the neural cell based on what the neural cell learns from the received sensory data; and
a digital input/output interface communicatively coupled to the memory cell and
configured to interface the ISN-MCU to a digital domain;
wherein each of the ISN-MCUs are configured to perform a learning operation in parallel with the other ISN-MCUs to learn from sensory data in an external environment based on receiving the command from the control channel.

11. An apparatus comprising:
a plurality of ADI-PLUs of claim 9, arranged in a hierarchical manner; and
a hierarchical non-blocking interconnect module configured to interconnect the plurality of ADI-PLUs.

12. The apparatus of claim 11, further comprising a lookup and forwarding table configured to provide automatic forwarding of data between the plurality of ADI-PLUs and their respective ISN-MCUs.

13. The ADI-PLU apparatus of claim 10, wherein the memory cell is a multi-bit memory cell comprising:
an input memory cell configured to store input sampler data received from the at least one sampler module;
a weight/adaptivity quotient memory cell configured to store weight/adaptivity quotient data; and
an output memory cell configured to store an inference.

14. The ADI-PLU apparatus of claim 10, wherein the ISN-MCU is configured to provide visual and auditory inferences;
wherein the one or more sense elements comprise audio and visual sensors.

15. The ADI-PLU apparatus of claim 10, wherein the ISN-MCU is configured to sense distance and imagery data, wherein the one or more sense elements comprise lidar sensors.

16. The ADI-PLU apparatus of claim 10, wherein the ISN-MCU is configured to identify chemicals, wherein the one or more sense elements comprise chemical sensors configured to convert chemical signatures into analyzable data.

17. The ADI-PLU apparatus of claim 16, wherein the chemical sensors comprise smell-based sensors.

18. The ADI-PLU apparatus of claim 16, wherein the chemical sensors comprise taste-based sensors.

19. The ADI-PLU apparatus of claim 10, wherein the ISN-MCU is configured to sense biological data, wherein the one or more sense elements comprise a biosensor.

20. The ADI-PLU apparatus of claim 10, wherein the ISN-MCU is configured to perform artificial intelligence (AI) model inference operations while simultaneously performing self-learning operations using techniques.
